(19) United States
(12) Patent Application Publication
(10) Pub. No.: US 2011/0318841 A1
(43) Pub. Date: Dec. 29, 2011

(54) Method for Determining Vanadium Content in a Tungsten Matrix with Added Vanadium or Simultaneously Added Chromium and Vanadium

(76) Inventor: Yiqi Hu, Jiangxi (CN)

(21) Appl. No.: 13/139,092

(22) PCT Filed: Dec. 9, 2009
(86) PCT No.: PCT/CN09/75421

§ 371 Date: Aug. 3, 2011

(30) Foreign Application Priority Data
Dec. 12, 2008 (CN) 200810239820.0

(51) Int. Cl. G01N 21/25

(52) U.S. Cl. 436/83

(57) ABSTRACT

A method for determining vanadium content in a tungsten matrix with singly added vanadium or simultaneously added chromium and vanadium, characterized in that a test sample is subjected to alkaline melting with sodium peroxide and water leaching followed by dry filtering, the chromium and vanadium in the filtrate are firstly reduced to low valences by a reducing agent, i.e. hydroxylamine hydrochloride, then the filtrate is adjusted to an acidity of 4-6 M with nitric acid, the vanadium is oxidized in a cold state to a high valence by potassium permanganate, and the high-valent vanadium forms a ternary complex with tungstate and orthophosphate, the darkness of the color of the ternary complex is directly proportional to the vanadium content, thus the vanadium content is determined colorimetrically, and the interference of chromium is eliminated with the fact that the potassium permanganate in a cold state in the acidic condition for vanadium determination oxidizes the vanadium but not the chromium. The method of the invention is relatively suitable for determining the macro-amount vanadium content in a tungsten matrix containing macro-amount vanadium singly or containing macro-amount vanadium and chromium simultaneously, the method is fast and accurate with a relative error less than 5%, which can fully satisfy the requirements of the production process for the determination.

### TECHNICAL FIELD

The present invention relates to a method for determining vanadium content in a tungsten matrix with added vanadium or simultaneously added chromium and vanadium.

The term “tungstovanadophosphoric acid photometry” herein refers to the following process: a test sample is subjected to alkaline melting with sodium peroxide and water leaching followed by dry filtering, the chromium and vanadium in the filtrate are firstly reduced to low valences by a reducing agent, i.e. hydroxylamine hydrochloride, then the filtrate is adjusted to an acidity of 4-6 M with nitric acid, the vanadium is oxidized in a cold state to a high valence by potassium permanganate, and the high-valent vanadium forms a ternary complex with tungstate and orthophosphate, the darkness of the color of the ternary complex is directly proportional to the vanadium content, thus the vanadium content is determined colorimetrically. The interference of chromium is eliminated by utilizing the property that the potassium permanganate in a cold state in the acidic condition for vanadium determination oxidizes the vanadium but not the chromium, chromium remains at low valence state, it does not participate in the color development reaction, and does not interfere with the determination of vanadium.

The term “matrix” herein is also referred to as “medium” or “base material”.

The term “tungsten matrix” herein refers to a sample for analysis, in which all the materials and components except the analytes are tungsten, such as tungsten carbide and the like.

### PRIOR ART

In production of fine or ultra-fine particulate tungsten carbide powders, it is often necessary to add chromium and vanadium compounds separately or simultaneously. There are no standard macroanalytical methods for chromium and vanadium in the existing analytical methods. And as there is interference between chromium and vanadium, it becomes more difficult to measure the contents of chromium and vanadium accurately when chromium and vanadium are simultaneously added. In tungsten industry, large companies typically carry out the simultaneous determination of chromium and vanadium, etc. by means of X-ray fluorescence analyzer; and the method is fast and accurate. However, the prices of X ray fluorescence analyzer are up to millions of RMB Yuan or more, so small and medium-sized enterprises generally do not have such high-end test equipments.

Whether or not the chromium and vanadium are added at the exact amounts will directly affect the qualities of downstream hard alloy products.

In prior art, macroanalysis of vanadium is often carried out by means of redox titration. However, it is somewhat bothersome, as the results have to be corrected with the indicator at each time, based on the absolute amount of vanadium in the sample solution; and the titration coefficient of the standard solution against vanadium is very large, so the sample blank has a very significant effect on the test result; when the vanadium content is low, the effect of sample blank would result in a relative error of more than 10.00% for the test result, thus the accuracy of analysis cannot meet the requirements of production process for testing.

### SUMMARY OF THE INVENTION

An object of the present invention is to provide a method for determining vanadium content in a tungsten matrix with added vanadium or simultaneously added chromium and vanadium, which can improve the accuracy and speed of the determination of vanadium content in a tungsten matrix with singly added vanadium or simultaneously added chromium and vanadium.

To this end, the present invention provides a method for determining vanadium content in a tungsten matrix with singly added vanadium or simultaneously added chromium and vanadium, characterized in that, a test sample is subjected to alkaline melting with sodium peroxide and water leaching followed by dry filtering, the chromium and vanadium in the filtrate are firstly reduced to low valences by a reducing agent, i.e. hydroxylamine hydrochloride, then the filtrate is adjusted to an acidity of 4-6 M with nitric acid, the vanadium is oxidized in a cold state to a high valence by potassium permanganate, and the high-valent vanadium forms a ternary complex with tungstate and orthophosphate, the darkness of the color of the ternary complex is directly proportional to the vanadium content, thus the vanadium content is determined colorimetrically. The interference of chromium is eliminated according to the property that the potassium permanganate in a cold state in the acidic condition for vanadium determination oxidizes the vanadium but not the chromium.

Since the main body of tungsten participates in the formation of the ternary complex, while the excess phosphoric acid, which is another participant in the formation of the ternary complex, can coordinate with excess tungsten matrix, thus preventing tungstic acid from precipitating to affect the colorimetric determination of vanadium. Therefore, the present invention is more suitable for determining the macro-amount vanadium content in a tungsten matrix, if macro-amount chromium is also included, the interference of chromium is eliminated with the fact that the potassium permanganate in a cold state in the acidic condition for vanadium determination oxidizes the vanadium but not the chromium. As the colorimetrical coefficient of tungstovanadophosphoric acid photometry is far less than titration coefficient, sample blanks have little effects on testing results, thus the photometry has a higher accuracy of analysis than the redox titration has, and the colorimetric solution can be stable for a long time after color developing, so the test reproducibility is fine. This further illustrates that the tungstovanadophosphoric acid photometry is more suitable for the macroanalysis of vanadium. The method is fast and accurate with a relative error less than 5%, which can fully satisfy the requirements of the production process for measurement.

The interference of chromium is eliminated as follows: the chromium and vanadium are firstly reduced to low valences by a reducing agent, i.e. hydroxylamine hydrochloride, in an alkaline filtrate taken separately after dry filtering, then the acidity is adjusted to 4-6 M with nitric acid; after cooling, vanadium is oxidized to a high valence by potassium permanganate, chromium is not oxidized, so it does not participate in the color development reaction, therefore it does not interfere with the determination of vanadium.

### DETAILED DESCRIPTION OF THE INVENTION

Below is detailed description of the method for determining vanadium content in a tungsten matrix, such as tungsten carbide and the like, with singly added vanadium or simultaneously added chromium and vanadium by tungstovanadophosphoric acid photometry.

1. Applicability:

This method is useful for determining vanadium content in a tungsten matrix, such as tungsten carbide powders and the like, with singly added vanadium or simultaneously added chromium and vanadium. Measuring range: 0.05-1.00%.

2. Tips of the Method:

In a medium of nitric acid, high-valent vanadium forms a ternary complex with tungstate and orthophosphate, the darkness of the color of which is directly proportional to the vanadium content, thus the vanadium content is determined colorimetrically; and in which the interference of chromium is eliminated by utilizing the property that the potassium permanganate oxidizes the vanadium but not the chromium in appropriate acidities.

3. Reagent:

3.1 Nitric acid AR, (1+1)

3.2 Phosphoric acid AR, (1+1)

3.3 Sodium tungstate solution AR, (15 g/L)

3.4 p-Nitrophenol solution AR, (1 g/L)

3.5 Sodium peroxide AR

3.6 Hydroxylamine hydrochloride solution AR, (10 g/L)

3.7 Potassium permanganate solution AR, (10 g/L)

3.8 Sodium nitrite solution AR, (100 g/L)

3.9 Vanadium standard solution:

3.9.1 Weighing 0.1785 g of vanadium pentoxide (>99.9%) and dissolving it in a small amount of sodium hydroxide solution (10 g/L), acidifying by adding a small amount of sulfuric acid (1+49), transferring it into a 1000 mL volumetric flask, and diluting with water to volume and shaking well. 1 mL of this solution contains 100 μg of vanadium.

3.9.2 Pipetting 10.00 mL vanadium standard solution (3.9.1) into a 100 mL volumetric flask, and diluting to volume and shaking well. 1 mL of this solution contains 10 μg of Vanadium.

4. Instrument

Model 721 spectrophotometer

5. Analytical procedures:

5.1 Sample weight: weighing 0.5-1 g of a sample, and being accurate to 0.0001 g.

5.2 Blank test: performing a blank test along with the sample.

5.3 Measurement

5.3.1 Placing a sample (5.1) in a porcelain crucible, calcining at 780° C. in a muffle furnace for 1.5-2 h to convert it totally to tungsten trioxide.

5.3.2 Placing (5.3.1) in a iron crucible provided with approximately 4 g of pre-placed sodium peroxide (3.5), then covering it with a thin layer of sodium peroxide, placing it in a muffle furnace at 750° C. to melt until it is red and clear, then taking it out and cooling.

5.3.3 Placing it into a 300 mL beaker containing 50 mL hot water for leaching, eluting out from the crucible with water. Heating by an electric furnace to boiling and gently boiling for 2-3 min, taking it out and cooling, transferring the solution and precipitation from the beaker to a 100 mL volumetric flask by water, diluting to volume and shaking well. Dry filtering after being clarified, pipetting 5.00-10 mL filtrate into a 25 mL colorimetric tube, adding one drop of hydroxylamine hydrochloride solution (3.6), shaking well and standing still for 1 min. Adding one drop of p-nitrophenol solution (3.4), neutralizing with nitric acid (3.1) just to the disappearance of the yellow-green color, (in the case of also having chromium mixed, adding 2.5 mL phosphoric acid (3.2) and shaking well, adding potassium permanganate solution (3.7) dropwisely until red color appears and does not fade away in 3 minutes, adding sodium nitrite solution (3.8) dropwisely until red color disappears and adding one more drop, shaking well) and shaking well, adding 5 mL nitric acid (3.1) and shaking well, adding 1.5 mL sodium tungstate solution (3.3) and shaking well, cooling, diluting to volume and shaking well.

5.3.4 Heating in a boiling water bath for 20 min, taking it out and cooling. Measuring the absorbance at 420 nm with a Model 721 spectrophotometer and a 3 cm colorimetric cell with water as reference solution, subtracting the absorbance for the blank solution from the measured absorbance thereof, then finding out the corresponding vanadium content from a working curve.

5.4 Plotting the working curve:

Accurately pipetting 0, 20, 40, 80, 100, and 120 μg of vanadium into a set of 25 mL colorimetric tubes, adding one drop of hydroxylamine hydrochloride solution (3.6), shaking well and standing still for 1 min. Next following the operations of 5.3.3 and 5.3.4. Plotting the working curve with absorbance as ordinate against vanadium content as abscissa.

6. The calculation of the results:

The vanadium content is calculated according to the following equation:

$$V ( \% ) = \frac{( r - {r}_{0} ) \times {V}_{0} \times {10}^{- 6}}{m \times V} \times 100 ( \% )$$

Wherein:
r is the vanadium content identified from the working curve for sample solution, μg;
r₀ is the vanadium content identified from the working curve for blank solution, μg;
V is the volume of test solution taken separately, mL;
V₀ is the total volume of test solution, mL;
m is the sample weight, g.

1. A method for determining vanadium content in a tungsten matrix with singly added vanadium or simultaneously added chromium and vanadium, characterized in that a test sample is subjected to alkaline melting by sodium peroxide and water leaching followed by dry filtering, the chromium and vanadium in the filtrate are firstly reduced to low valences by a reducing agent of hydroxylamine hydrochloride, then the filtrate is adjusted to an acidity of 4-6 M with nitric acid, the vanadium is oxidized in a cold state to a high valence by potassium permanganate, and the high-valent vanadium forms a ternary complex with tungstate and orthophosphate, the darkness of the color of the ternary complex is directly proportional to the vanadium content, thus the vanadium content is determined colorimetrically; the interference of chromium is eliminated according to such a property that the potassium permanganate in a cold state in the acidic condition for vanadium determination oxidizes the vanadium but not the chromium.

2. The method for determining vanadium content in a tungsten matrix according to claim 1, characterized in that, the following reagents are used:
3.1 Nitric acid AR, (1+1)
3.2 Phosphoric acid AR, (1+1)
3.3 Sodium tungstate solution AR, (15 g/L)
3.4 p-Nitrophenol solution AR, (1 g/L)
3.5 Sodium peroxide AR
3.6 Hydroxylamine hydrochloride solution AR, (10 g/L)
3.7 Potassium permanganate solution AR, (10 g/L)
3.8 Sodium nitrite solution AR, (100 g/L)
3.9 Vanadium standard solution.

3. The method for determining vanadium content in a tungsten matrix according to claim 2, characterized in that, the vanadium standard solution is prepared as follows:
3.9.1 Weighing 0.1785 g of vanadium pentoxide (>99.9%) and dissolving it in a small amount of sodium hydroxide solution (10 g/L), acidifying by adding a small amount of sulfuric acid (1+49), transferring it into a 1000 mL volumetric flask, diluting with water to volume and shaking well, so 1 mL of this solution contains 100 μg of vanadium; and
3.9.2 Pipetting 10.00 mL vanadium standard solution (3.9.1) into a 100 mL volumetric flask, diluting to volume and shaking well, so 1 mL of this solution contains 10 μg of vanadium.

4. The method for determining vanadium content in a tungsten matrix according to claim 1, characterized in that, spectrophotometry is employed.

5. The method for determining vanadium content in a tungsten matrix according to claim 1, characterized in that, the analytical steps are as follows:
5.1 Sample weight: weighing 0.5-1 g of a sample being accurate to 0.0001 g;
5.2 Blank test: performing a blank test along with the sample;
5.3 Measurement;
5.4 Plotting a working curve:
accurately pipetting 0, 20, 40, 80, 100, and 120 μg of vanadium into a set of 25 mL colorimetric tubes, adding one drop of hydroxylamine hydrochloride solution (3.6), shaking well and standing still for 1 min; next following the operations of 5.3.3 and 5.3.4; then plotting the working curve with absorbance as ordinate against vanadium content as abscissa.

6. The method for determining vanadium content in a tungsten matrix according to claim 5, characterized in that, the measurement includes:
5.3.1 Placing a sample (5.1) in a porcelain crucible, calcining at 780° C. in a muffle furnace for 1.5-2h to convert it totally to tungsten trioxide;
5.3.2 Placing (5.3.1) in a iron crucible provided with approximately 4 g of pre-placed sodium peroxide (3.5), then covering it with a thin layer of sodium peroxide, placing it in a muffle furnace at 750° C. to melt for 10 minutes until it is red and clear, then taking it out and cooling;
5.3.3 Placing it into a 300 mL beaker containing 50 mL hot water for leaching, eluting out from the crucible with water; heating by an electric furnace to boiling and gently boiling for 2-3 min, taking it out and cooling, transferring the solution and precipitation from the beaker to a 100 mL volumetric flask by water, diluting to volume and shaking well; dry filtering after being clarified, pipetting 5.00-10 mL filtrate into a 25 mL colorimetric tube, adding one drop of hydroxylamine hydrochloride solution (3.6), shaking well and standing still for 1 min, adding one drop of p-nitrophenol solution (3.4), neutralizing with nitric acid (3.1) just to the disappearance of the yellow-green color, shaking well, adding 5 mL nitric acid (3.1) and shaking well, adding 2.5 mL phosphoric acid (3.2) and shaking well, adding 1.5 mL sodium tungstate solution (3.3) and shaking well, cooling, then diluting to volume and shaking well; and
5.3.4 Heating in a boiling water bath for 20 min, taking it out and cooling; measuring the absorbance at 420 nm with a Model 721 spectrophotometer and a 3 cm colorimetric cell with water as reference solution, subtracting the absorbance for the blank solution from the measured absorbance thereof, then finding out the corresponding vanadium content from the working curve.

7. The method for determining vanadium content in a tungsten matrix according to claim 6, characterized in that, in step 5.3.3, in the case of also having chromium mixed, pipetting 5.00-10 mL filtrate into a 25 mL colorimetric tube, adding one drop of hydroxylamine hydrochloride solution (3.6), shaking well and standing still for 1 min, adding one drop of p-nitrophenol solution (3.4), neutralizing with nitric acid (3.1) just to the disappearance of the yellow-green color, shaking well, adding 2.5 mL phosphoric acid (3.2), shaking well and cooling to room temperature, adding potassium permanganate solution (3.7) dropwisely until red color appears and does not fade away in 3 minutes, shaking while adding sodium nitrite solution (3.8) dropwisely until red color disappears and adding one more drop, shaking well, adding 5 mL nitric acid (3.1) and shaking well, adding 1.5 mL sodium tungstate solution (3.3) and shaking well, cooling, then diluting to volume and shaking well.

8. The method for determining vanadium content in a tungsten matrix according to claim 5, characterized in that, the vanadium content is calculated according to the following equation:
$$V ( \% ) = \frac{( r - {r}_{0} ) \times {V}_{0} \times {10}^{- 6}}{m \times V} \times 100 ( \% )$$
Wherein:
r is the vanadium content identified from the working curve for sample solution, μg;
r₀ is the vanadium content identified from the working curve for blank solution, μg;
V is the volume of test solution taken separately, mL;
V₀ is the total volume of test solution, mL; and
m is the sample weight, g.
